(19) United States
(12) Patent Application Publication
(10) Pub. No.: US 2013/0236629 A1
(43) Pub. Date: Sep. 12, 2013

(54) SWEETENING COMPOSITIONS INCLUDING REBAUDIOSIDES AND METHODS OF PREPARATION

(71) Applicant: DR PEPPER/SEVEN UP, INC., Plano, TX (US)

(72) Inventors: Stacey K. Walton, Frisco, TX (US); Sarah M. Erdman, McKinney, TX (US); Gino E. Olcese, Allen, TX (US)

(73) Assignee: DR PEPPER/SEVEN UP, INC., Plano, TX (US)

(21) Appl. No.: 13/785,884

(22) Filed: Mar. 5, 2013

Related U.S. Application Data
(60) Provisional application No. 61/607,395, filed on Mar. 6, 2012.

(51) Int. Cl. A23L 1/236

(52) U.S. Cl. CPC A23L 1/2363
USPC 426/658; 426/520

(57) ABSTRACT

A method of preparing a sweetening composition may include providing a stevia extract and heating the extract under acidic conditions. Treatment may subject the stevia extract to conditions sufficient to alter the glycoside composition of the extract, suppress bitter aftertastes, or provide a sweetening composition with a taste profile similar to that of sucrose sugar.

### CROSS REFERENCE TO RELATED APPLICATIONS

This application claims priority to U.S. Provisional Application Ser. No. 61/607,395 filed Mar. 6, 2012. The disclosure of the aforementioned application is incorporated herein by reference.

### FIELD

The present application relates to rebaudioside-comprising compositions suitable for use as sweeteners in a variety of foods and beverages and to methods of producing such compositions.

### BACKGROUND

Steviol glycosides are natural sweeteners that may be obtained from plants of Stevia rebaudiana (S. rebaudiana). Such sweeteners are attractive options for use in food products because they are highly sweet yet have low caloric content. Steviol glycosides may include, for example, stevioside, dulcoside, and the rebaudiosides, including rebaudioside-A (Reb A), rebaudioside-B (Reb B), rebaudioside-C (Reb C), rebaudioside-D (Reb D), and rebaudioside-E (Reb E). The non-carbohydrate moiety of steviol glycosides may include a central diterpene core, as illustrated in Formula I.

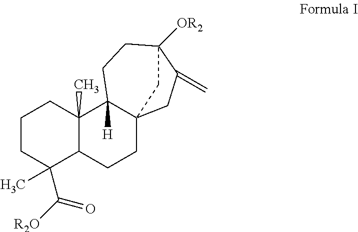

Substitution of hydrogen for both R₁ and R₂ yields steviol, an aglycone product from which the steviol glycosides may be built. Substitution of R₁ and R₂ with various combinations of hydrogen, glucose, or other sugars such as xylose or rhamnose provide the various structures of the steviol glycosides.

Of the naturally occurring steviol glycosides in a typical stevia extract, stevioside and rebaudioside-A may comprise the highest fractions by weight. Rebaudioside-A is highly sweet with a relative sweetness at least about 200 times that of sucrose; however, rebaudioside-A, particularly at high concentrations, possesses a non-ideal bitter aftertaste and has been characterized as possessing various off-notes (often described as licorice-like). Stevioside, which is also a highly sweet material, has typically been found to possess a greater level of bitterness than rebaudioside-A. None of the naturally occurring steviol glycosides provide exactly the same profile for sweetness perception as does the natural sugar sucrose, which provides an ideal sweetness. For example, the temporal profiles for delivery of sweetness of the individual rebaudiosides are generally delayed and longer in duration than that provided by sucrose.

It would be desirable to produce rebaudioside-comprising compositions that suppress bitter aftertastes and provide a taste profile that is more similar to natural sugars, such as sucrose. There is also a need for robust and cost effective strategies for the production of such rebaudioside-comprising compositions.

### SUMMARY

In some embodiments, methods are provided for treating a stevia extract. The resulting treated compositions are highly sweet, possess improved taste characteristics, and may be used as sweetening compositions in the production of food and beverage products. In some embodiments, methods may comprise providing rebaudioside-A or mixtures of rebaudioside-A and stevioside and subjecting those compositions to modification by addition of acidic pH and processing at elevated temperatures.

In some embodiments, a sweetening composition may be produced by subjecting a stevia extract to a pH of about 1.2 to about 3.8 and a temperature between about 40° C. to about 90° C. Heat and acid may, in some embodiments, be provided for a period of not more than about 10 hours.

### BRIEF DESCRIPTION OF THE DRAWINGS

FIG. 1 is a flowchart showing a method of producing a sweetening composition.

FIG. 2 is a flowchart showing another method of producing a sweetening composition.

### DETAILED DESCRIPTION

The following terms as used herein should be understood to have the indicated meanings.

When an item is introduced by “a” or “an,” it should be understood to mean one or more of that item.

“Comprises” means includes but is not limited to.

“Comprising” means including but not limited to.

“Having” means including but not limited to.

The term “beverage” as used herein means any drinkable liquid or semi-liquid, including for example flavored water, soft drinks, fruit drinks, slush products, smoothies, coffee-based drinks, tea-based drinks, juice-based drinks, milk-based drinks, gel drinks, carbonated or non-carbonated drinks, alcoholic or non-alcoholic drinks.

The term “consumable item” means anything that may be orally ingested by a consumer, including without limitation a food, beverage, pharmaceutical composition, nutraceutical composition, vitamin, lozenge, dietary supplement, confection, chewing gum, candy and a combination of any of the foregoing.

The term “stevia extract” means a material comprising at least one steviol glycoside and derived from Stevia rebaudiana.

This disclosure is directed to sweetening compositions derived from the stevia plant as well as to methods of producing such compositions. The sweetening compositions described herein may be produced by subjecting a stevia extract to an acidic environment under elevated temperature conditions. Such treatment may, for example, modify the distribution of sweet tasting steviol glycosides in the stevia extract. For example, in some embodiments, the treatment may initiate various chemical reactions including hydrolysis reactions, condensation reactions, other reactions, or combinations thereof that may modify the carbohydrate portion of steviol glycosides. In some embodiments, the sweetening composition may comprise a modified distribution of sweet tasting components and may provide, upon consumption, an improved taste as compared to the starting composition, i.e., untreated stevia extract.

In some embodiments, improvements in taste for sweetening compositions described herein, e.g., treated stevia extracts, may be related to the suppression of at least one negative characteristic commonly associated with stevia extracts that have not been treated. For example, untreated stevia extracts may provide a sweetness profile that is different from that of natural sugar and may possess off-taste properties such as bitter, metallic or licorice-like aftertaste, or combinations of the foregoing. Sweetening compositions described herein may possess a sweetness profile that is more similar to that of natural sugar and may have decreased bitterness or other off-tastes. In some embodiments, the bitterness, or presence of other off-tastes, in a sweetening composition may be improved in relation to that of an untreated stevia extract.

For example, samples, including the sweetening composition (treated extract) and the untreated stevia extract, may be evaluated by trained sensory panelists. Beverage sampling may comprise taking an about 10 mL portion of the beverage into the mouth, holding the sample in the mouth, and rating, e.g., the sweetness time intensity profile, aftertaste, mouthfeel, other properties, or combinations of properties thereof for each sample. Panelists may, for example, rate a beverage based on a 9-point scale. Any number of panelists may rate that the treated stevia extract (sweetening composition) may show an improvement in bitterness, other off-tastes and/or show an improved sweetness profile as compared to the extract prior to treatment. For example, in some embodiments, the percentage of panelists that rate that the treated composition has improved bitterness or has improved in other off-tastes as compared to the untreated stevia extract (prior to modification) may be at least about 25%, at least about 50%, at least about 75%, or at least about 90%.

In some embodiments, the stevia extract (prior to application of heat and acid as described herein) may be a substantially purified rebaudioside-A composition. Such a sample may, for example, comprise substantially purified rebaudioside-A at a weight fraction of at least about 95%, or at least about 99%. The remaining fraction of the starting sample may comprise stevioside and other components in small or trace amounts. In some embodiments, the stevia extract (prior to application of heat and acid as described herein) may be a substantially purified stevioside composition. The stevioside composition may, for example, comprise substantially purified stevioside at a weight fraction of at least about 95%, or at least about 99%. The remaining fraction of the starting sample may comprise rebaudioside-A and other components in small or trace amounts. In some embodiments, the stevia extract, prior to treatment, may include a mixture of rebaudioside-A and stevioside. For example, in some embodiments, the ratio of rebaudioside-A to stevioside may be about 1:0.05 to about 1:0.1, about 1:0.1 to about 1:0.25, or about 1:0.25 to about 1:1.

Treatment of a stevia extract may comprise the addition of heat and the addition of acid. In some embodiments, an acceptable acid or combination of acids sufficient to lower the pH to about 1.2 to about 3.8 may be used. In some embodiments, the pH for treatment of a stevia extract may be about 1.2 to about 3.8, or about 1.8 to about 2.5. Within the pH range of about 1.2 to about 3.8, the lower boundary of pH may be about 1.2, about 1.8, or about 2.2. Also within the pH range of about 1.2 to about 3.8, the upper boundary of pH may be about 3.8, about 3.2 or about 2.8. In some embodiments, the temperature for modification of a stevia extract may be about 40° C. to about 90° C., or about 65° C. to about 85° C. A sample may be subjected to about the target temperature for a period of less than about 10 hours, less than about 2 hours, less than about 1 hour, less than about 30 minutes, or about 10 minutes. Any of various quantities of stevia extract may be treated, e.g., single serving sizes or industrial sized portions. In some embodiments of methods, including, but not limited to, methods that involve treatment of larger batches and/or batches where rapid and/or uniform heating may be difficult, the composition may be stirred. In addition, efforts may be made to minimize the proportion of time, e.g., as compared to the overall process time, that may be attributed to heating and cooling stages of a process. For example, in some embodiments, the proportion of time for a thermal cycle where a batch is within about 5° C. of the target temperature may be greater than about 50%, greater than 75%, or greater than about 90%. In some embodiments, stevia extract may be chemically modified by treatment for about 10 minutes at about 90° C. at a pH of about 2.3 using an acidic triblend of citric acid, malic acid and phosphoric acid.

Suitable acids may, for some embodiments, include citric acid, malic acid, phosphoric acid, another acid, or combinations thereof. In some embodiments, the pH may be buffered by a combination of two or more food grade acids. For example, acid combinations may include citric acid and malic acid, malic acid and phosphoric acid, citric acid and phosphoric acid, or a triblend of citric, malic, and phosphoric acid. In some embodiments, the one or more acids useful for treating a stevia extract may consist of food grade acids, such as citric acid, malic acid, and phosphoric acid.

In some embodiments, a treated composition, e.g., composition after being subjected to heat and acid, may include partially hydrolyzed and/or condensed products and may comprise more than one sweet tasting steviol glycoside. For example, in some embodiments, a substantially pure rebaudioside-A composition may be subjected to heat and acid under conditions of severity to chemically modify up to about 50% or more of the available rebaudioside-A concentration. In some embodiments, a rebaudioside-A composition may be subjected to heat and acid under conditions such that about 25% to about 50% of the rebaudioside-A has been converted to other products, including by way of nonlimiting example stevioside, rebaudioside-B, rebaudioside-D, and rebaudioside-F. Thus, in some embodiments, the remaining proportion of rebaudioside-A may be about 50% to about 75%.

After treatment, the treated composition may be processed in any of various ways. For example, the treated composition may be passively or actively cooled (e.g., using a dedicated cooler) or the pH of the treated composition may be modified by the addition of food-grade compounds such as ammonium hydroxide, sodium carbonate, potassium carbonate, sodium bicarbonate, other alkaline reagents, and a combination comprising any of the foregoing. In some embodiments, alkaline reagents may be added to raise the pH of the solution to a pH of about 2.8 to about 5.0. In other embodiments, a sweetening composition may be buffered to a pH that is about the pH of a final composition to which it will eventually be added. In some embodiments, cooling of the reaction mixture and/or the addition of alkaline reagents may serve to suppress or terminate hydrolysis reactions.

Other materials, such as preservatives, salts, flavor modifiers, sweetness potentiators or other additives may also be added. The sweetening composition may be added to a consumable item or packaged and stored for later use. In some embodiments, the treated composition may be used without, for example, implementation of a technique such as preparative chromatography, extraction or another technique directed to the purification of a particular steviol glycoside over another. Thus, in some embodiments, the steviol glycoside composition may not be substantially modified following the application of heat and acid.

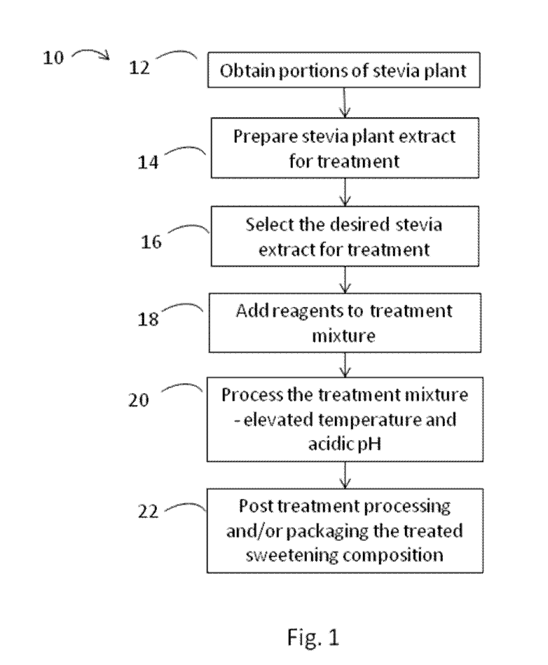

One embodiment of a method 10 for the production of a sweetening composition is shown in FIG. 1. In a step 12, a source of sweet tasting glycosides (Stevia rebaudiana) may be selected and portions of the stevia plant obtained for use. Sweet tasting glycosides may, for example, be present in the stems, seeds and leaves of the plant. In a step 14, a stevia plant extract containing sweet tasting glycosides may, at least in part, be prepared for treatment. For example, the composition may be treated to at least in part isolate or purify one or more steviol glycosides. Any acceptable method for purification of steviol glycosides may be used, such as, for example, those methods involving microfiltration, ultrafiltration, nanofiltration (as described in U.S. Pat. No. 5,972,120), preparative chromatography, use of ion exchange resins (as described in U.S. Pat. No. 5,962,678), recrystallization, filtration and combinations thereof. The disclosures of U.S. Pat. No. 5,972,120 and U.S. Pat. No. 5,962,678 are herein incorporated by reference.

In a step 16, a desired stevia extract for treatment may be selected. For example, as described herein, the desired extract may, in some embodiments, be a substantially purified composition comprising rebaudioside-A, stevioside, or combinations thereof. In a step 18, reagents for treatment of the stevia extract may be added. For example, one or more acids, as described previously, may be added and the one or more acids may be selected to modify the pH of the reaction mixture to a pH between about 1.2 to about 3.8. Heat may further be added and the temperature of the mixture may, for example, be increased to about 40° C. to about 90° C. The treatment mixture, e.g., mixture comprising stevia extract and one or more acids, may be processed (as shown in step 20) for a period of time up to, for example, about 10 hours or processed for a period of time to modify, e.g., hydrolyze or condense, a desired portion of glycosides in the starting reaction mixture. The reaction mixture may, in some embodiments, be substantially aqueous. In some embodiments, a carbohydrate such as a monosaccharide may be added to the treatment mixture. In a step 22, post treatment processing and/or packaging may occur. For example, the treatment mixture, e.g., chemically modified composition with an altered distribution of steviol glycosides, may be cooled and/or adjusted in pH, such as to terminate or suppress chemical reactions that have not come to equilibrium. Any of various additives may be added to the treated composition (sweetening composition) and the sweetening composition may be packaged or stored. In some embodiments, the treated composition may be added to a food or beverage item immediately following processing.

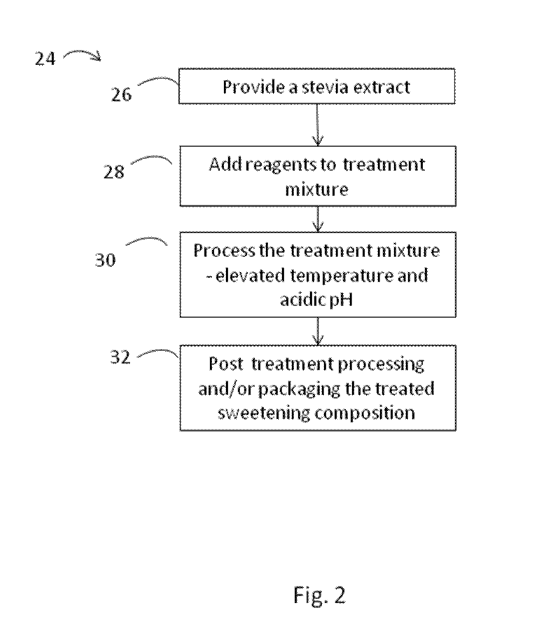

Another embodiment of a method 24 for the production of a sweetening composition is shown in FIG. 2. In a step 26 of method 24, a stevia extract or chemically similar source may be provided or selected for use. For example, the composition that is provided may, in some embodiments, comprise rebaudioside-A, stevioside or a mixture of those components. In some embodiments, the starting material selected (provided in step 26) may comprise rebaudioside-A, stevioside or a combination of both, and may, in some embodiments, further include no more than about 5% by weight, or no more than about 1% by weight, of other steviol glycosides or of an aglycone product of a steviol glycoside.

In a step 28, reagents for chemical modification of the selected materials may be added. For example, as discussed above, one or more acids may be added. As indicated at step 30, heat may further be added, and the treatment mixture may be processed for pH. As discussed above, the treatment mixture may be processed for a period of time up to, for example, about 10 hours or a period of time to modify, e.g., hydrolyze or condense, a desired portion of glycosides in the starting reaction mixture. In a step 32, the treatment mixture, e.g., treated composition, may be processed and/or packaged for use as a sweetening composition.

Sweetening compositions as described herein may be added to various beverages including by way of nonlimiting example soft drinks, fruit drinks, slush products, smoothies, coffee-based drinks, tea-based drinks, juice-based drinks, milk-based drinks, gel drinks, carbonated or non-carbonated drinks, alcoholic or non-alcoholic drinks or may be added to another consumable item.

A consumable composition may include additives such as caffeine, coloring agents (“colorants”, “colorings”), emulsifiers, food-grade acids, minerals, micronutrients, plant extracts, preservatives, salts including buffering salts, stabilizers, thickening agents, medicaments, and a combination comprising any of the foregoing. Those of ordinary skill in the art will understand that certain additives may meet the definition or function according to more than one of the above-listed additive categories.

The pH of a consumable composition may also be modified by the addition of food-grade compounds such as ammonium hydroxide, sodium carbonate, potassium carbonate, sodium bicarbonate, and the like, and a combination comprising any of the foregoing. Additionally, the pH may be adjusted by the addition of carbon dioxide.

A person having ordinary skill in the art will understand that embodiments of compositions may contain one or more flavors. Exemplary flavor oils may include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil; useful flavoring agents may include artificial, natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, prune, raisin, cola, guarana, neroli, pineapple, apricot, banana, melon, apricot, ume, cherry, raspberry, blackberry, tropical fruit, mango, mangosteen, pomegranate, papaya and so forth. Additional exemplary flavors imparted by a flavoring agent may include a milk flavor, a butter flavor, a cheese flavor, a cream flavor, and a yogurt flavor; a vanilla flavor; tea or coffee flavors, such as a green tea flavor, an oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a camomile flavor, a mustard flavor, a cardamon flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; a nut flavor such as an almond flavor, a hazelnut flavor, a macadamia nut flavor, a peanut flavor, a pecan flavor, a pistachio flavor, and a walnut flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor.

In some embodiments, other flavoring agents may include aldehydes and esters such as cinnamyl acetate, cinnamaldehyde, citral diethylacetal, dihydrocarvyl acetate, eugenyl formate, p-methylamisol, and so forth. Examples of aldehyde flavorings may include acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), and the like.

The flavoring agents may be used in liquid or solid/dried form and may be used individually or in a mixture. When employed in dried form, suitable drying means such as spray drying an oil may be used. Alternatively, the flavoring agent may be absorbed onto water-soluble materials, such as cellulose, starch, sugar, maltodextrin, gum arabic and so forth or may be encapsulated. In still other embodiments, the flavoring agent may be adsorbed onto silicas, zeolites, and the like. The techniques for preparing such dried forms are well-known.

In some embodiments, the flavoring agents may be used in many distinct physical forms. Without being limited thereto, such physical forms may include free forms, such as spray dried, powdered, beaded forms, encapsulated forms, emulsions such as caramel or gum arabic emulsions, and a combination comprising at least one of the foregoing physical forms. The particular amount of the flavoring agent effective for imparting flavor characteristics to the composition may depend upon several factors including the flavor, the flavor impression, and the like.

In some embodiments, the tartness of a beverage may be varied by selecting and combining acids to provide a desired tartness perception. Some factors to consider in determining a desired tartness may include, for example, the acid's dissociation constant, solubility, pH, etc. These variables may be measured by measuring the titratable acidity of a consumable item or concentrate.

In some embodiments, a coloring agent may be used in amounts effective to produce a desired color for the composition. Exemplary coloring agents may include pigments, natural food colors and dyes suitable for food, drug and cosmetic applications. A full recitation of all colorants approved by the United States Food and Drug Administration, together with corresponding chemical structures, may be found in the Kirk-Othmer Encyclopedia of Chemical Technology, 3rd Edition, in volume 5 at pages 857-884.

As classified by the United States Food, Drug, and Cosmetic Act (21 C.F.R. 73), colors may include those exempt from certification colors (sometimes referred to as natural even though they can be synthetically manufactured) and certified colors (sometimes referred to as artificial), and a combination comprising any of the foregoing. In some embodiments, exemplary colors exempt from certification or natural colors may include, for example, annatto extract, (E160b), bixin, norbixin, astaxanthin, dehydrated beets (beet powder), beetroot red/betanin (E162), ultramarine blue, canthaxanthin (E161g), cryptoxanthin (E161c), rubixanthin (E161d), violanxanthin (E161e), rhodoxanthin (E161f), caramel (E150(a-d)), β-apo-8′-carotenal (E160e), β-carotene (E160a), alpha carotene, gamma carotene, ethyl ester of beta-apo-8 carotenal (E160f), flavoxanthin (E161a), lutein (E161b), cochineal extract (E120); carmine (E132), carmoisine/azorubine (E122), sodium copper chlorophyllin (E141), chlorophyll (E140), toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (E100), turmeric oleoresin, amaranth (E123), capsanthin/capsorbin (E160c), lycopene (E160d), and a combination comprising any of the foregoing.

In some embodiments, exemplary certified colors may include FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythro sine (E127), patent blue V (E131), titanium dioxide (E171), aluminum (E173), silver (E174), gold (E175), pigment rubine/lithol rubine BK (E180), calcium carbonate (E170), carbon black (E153), black PN/brilliant black BN (E151), green S/acid brilliant green BS (E142), and a combination comprising any of the foregoing. In some embodiments, certified colors may include FD&C aluminum lakes, which consist of the aluminum salts of FD&C dyes extended on an insoluble substrate of alumina hydrate. Additionally, in some embodiments, certified colors may be included as calcium salts.

In some embodiments, a consumable composition may include additional preservatives to provide freshness and to prevent the unwanted growth of bacteria, molds, fungi, or yeast. The addition of a preservative, including antioxidants, may also be used to maintain the composition's color, flavor, or texture. Exemplary preservatives may include benzoic acid alkali metal salts (e.g., sodium benzoate), sorbic acid alkali metal salts (e.g., potassium sorbate), ascorbic acid (Vitamin C), citric acid, calcium propionate, sodium erythorbate, sodium nitrite, calcium sorbate, butylated hydroxyanisole (BHA), butylated hydroxytoluene (BHT), ethylenediaminetetraacetic acid (EDTA), tocopherols (Vitamin E), straight chain polyphosphates, and a combination comprising any of the foregoing preservatives.

### Example 1

A substantially purified sample of rebaudioside-A (in this example, about 99% purity) was treated with acid and heat. Ingredients listed in Table 1 were added and stirred at room temperature until dissolved. Water used in all beverages described herein was specifically purified prior to use by processes well-known in the art such as filtration, deionization, distillation, or reverse osmosis.

TABLE 1

| Ingredient | % (by weight) |
|---|---|
| Water | 97.47% |
| Sodium Benzoate | 0.03% |
| Phosphoric Acid | 0.50% |
| Malic Acid | 0.50% |
| Citric Acid | 0.50% |
| Rebaudioside-A (about 99% purity) | 1.00% |

The temperature of the solution was raised to about 90° C. and held for about 10 minutes. The solution was then cooled to room temperature. The treated sample was diluted by addition of 5 grams of the treated sample to about 95 grams of water. A 500 ppm solution of rebaudioside-A with 0.1% added citric acid was also prepared and used as a comparison sample. The comparison sample exhibited, upon consumption, typical stevia notes, such as bitter and licorice-like notes. The comparison sample further exhibited a noticeable level of astringency. The treated sample possessed a sugar note at the back end of the sweetness profile. In addition, bitter and licorice-like notes and astringency decreased with respect to the untreated sample.

The samples were separated in a reversed phase chromatographic column configured with a UV-Vis absorbance detection unit. Identification of peaks was assessed with respect to rebaudioside standards. Initial assessment of the treated sample indicated that the concentration of rebaudioside-A decreased with respect to the untreated sample.

While many examples in this description refer to compositions including a mixture of rebaudiosides and methods of preparation thereof, it is understood that those compositions and methods are described in an exemplary manner only and that other compositions and methods may be used. For example, any feature described for one embodiment may be used in any other embodiment. Additionally, other ingredients may be used, depending on the particular needs. Although the foregoing specific details describe certain embodiments, persons of ordinary skill in the art will recognize that various changes may be made in the details of these embodiments without departing from the spirit and scope of this invention as defined in the appended claims and other claims to be drawn to this invention, considering the doctrine of equivalents. Therefore, it should be understood that this invention is not limited to the specific details shown and described herein.

What is claimed is:

1. A method for the production of a sweet tasting composition comprising:
providing a stevia extract;
wherein said stevia extract comprises substantially pure rebaudioside-A;
treating the stevia extract at a temperature of about 40° C. to about 90° C. and a pH of about 1.2 to about 3.8 to form said sweet tasting composition; and
packaging the composition.

2. The method of claim 1 wherein the treating of stevia extract involves addition of heat for not more than about 10 hours.

3. The method of claim 1 wherein the treating of stevia extract involves addition of heat for not more than about 2 hours.

4. The method of claim 1 wherein the treating of stevia extract involves addition of heat for about 10 minutes to about 1 hour.

5. The method of claim 1 wherein the treating of stevia extract involves addition of heat for about 10 minutes.

6. The method of claim 1 wherein the treating of stevia extract converts up to about 50% of the rebaudioside-A present in the stevia extract.

7. The method of claim 1 wherein the treating of stevia extract converts about 50% to about 75% of the rebaudioside-A present in the stevia extract.

8. The method of claim 1 wherein the treating of stevia extract is at a pH of about 1.8 to about 2.5.

9. The method of claim 1 wherein the treating of stevia extract is at a temperature of about 65° C. to about 85° C.

10. The method of claim 1 wherein the treating of stevia extract is at a pH of about 2.3 and a temperature of about 90° C.

11. The method of claim 1 wherein the stevia extract comprises rebaudioside-A at a purity of at least about 95%.

12. The method of claim 1 wherein the stevia extract comprises rebaudioside-A at a purity of at least about 99%.

13. The method of claim 1 wherein the treating of stevia extract comprises addition of a food-grade acid.

14. The method of claim 1 wherein the treating of stevia extract comprises addition of an acid selected from the group of citric acid, malic acid, phosphoric acid, and a combination thereof.

15. The method of claim 1 wherein the treating of stevia extract comprises addition of a combination of acids, said combination of acids comprising phosphoric acid, malic acid and citric acid.

16. The method of claim 1 wherein the treating of stevia extract comprises addition of a combination of acids consisting of phosphoric acid, malic acid and citric acid.

17. The method of claim 1 wherein said packaging comprises addition of alkaline reagents; and
wherein the addition of the alkaline reagents raises the pH of the composition.

18. The method of claim 17 wherein the addition of the alkaline reagents raises the pH to a value of about 2.8 to about 5.0.

19. The method of claim 1 wherein the treating of stevia extract is performed under aqueous conditions.

20. A sweet tasting composition produced by the method of claim 1.

21. A method for the production of a sweet tasting composition comprising:
providing a stevia extract;
wherein said stevia extract comprises rebaudioside-A and stevioside;
treating the stevia extract at a temperature of about 40° C. to about 90° C. and a pH of about 1.2 to about 3.8 to form said sweet tasting composition; and
packaging the composition.

22. A sweet tasting composition produced by the method of claim 21.
